(19) United States
(12) Patent Application Publication
(10) Pub. No.: US 2016/0300000 A1
(43) Pub. Date: Oct. 13, 2016

(54) SYSTEM CONSTRUCTION SUPPORT APPARATUS

(71) Applicant: MITSUBISHI ELECTRIC CORPORATION, Tokyo (JP)

(72) Inventor: Naoki TAKESHITA, Tokyo (JP)

(73) Assignee: Mitsubishi Electric Corporation, Tokyo (JP)

(21) Appl. No.: 15/035,498

(22) PCT Filed: Nov. 26, 2013
(86) PCT No.: PCT/JP2013/081812

§ 371 Date: May 10, 2016

(51) Int. Cl. G06F 17/50

(52) U.S. Cl. CPC G06F 17/5009; G05B 2219/31341

(57) ABSTRACT

The invention comprises: a system design support tool being a system design support unit that imports profiles of respective devices constituting an FA system and uses data of the imported profiles to support designing of the FA system; and various simulators being a simulation unit that simulates an operation of the FA system designed by using the system design support unit. The system design support unit comprises a simulator cooperating function unit that causes the simulation unit to operate in cooperation with the system design support unit. The simulation unit comprises simulators for the respective devices. The system design support unit imports the profiles including simulator information for causing the respective simulators to operate in cooperation with the system design support unit, and thereby the simulator cooperating function unit uses the simulator information to cause the respective simulators to operate.

### FIELD

The present invention relates to a system construction support apparatus that enables a cooperation of a system design support tool and a simulator by using a profile.

### BACKGROUND

Conventionally, a system design support tool has been used for designing an FA (Factory Automation) system configured to include FA devices. The system design support tool can perform parameter setting and communication setting of respective devices as well as creation of a system configuration diagram (system design). Using the system design support tool can reduce the number of processes required for designing the FA system. A simulator has been used for checking and verifying an operation of the FA system that is designed by using the system design support tool. By using the simulator, it is possible to find a defect of a program prior to actual construction of the FA system, which can reduce the number of processes required for debugging.

As an example, a simulator that is implemented on the system design support tool is used for checking and verifying the operation of the FA system designed by using the system design support tool. In the case of the design support tool on which the simulator is implemented, it is difficult to implement the simulator in advance so as to support all kinds of devices that the system design support tool may handle. Therefore, there is a possibility that a device which is not supported by the simulator is included in the FA system designed by using the system design support tool. If simulation is not performed on a part of the devices in the FA system, it means that the operation check for the FA system as a whole is not performed. On the other hand, implementing a large number of simulators on the system design support tool in order to support all kinds of devices is hard to achieve in view of performance, data capacity, and development burden.

As another example, an external simulator that is prepared separately from the system design support tool is used for checking and verifying the operations of the FA system. According to a conventional technique, it is necessary for achieving a cooperation of the system design support tool and the external simulator to specially modify the system design support tool to develop a function that causes the system design support tool to operate in cooperation with the simulator. Moreover, every time a new device is handled by the system design support tool, it is necessary to develop the function for the cooperation with a simulator for the new device, which is difficult.

In view of the above, in either case where the simulator implemented on the system design support tool or the external simulator is used for checking and verifying the operation of the FA system, it is difficult to achieve the simulation for the entire FA system designed by using the system design support tool, which is a problem. In recent years, the FA system is provided with many kinds of devices. Every device tends to become multifunctional. A frequency of release of new devices tends to increase. In either case of the simulator implemented on the system design support tool or the external simulator cooperating with the system design support tool, repeating the modification in order to handle the new devices causes increase in workload and cost, which is a problem.

### CITATION LIST

### Patent Literature

Patent Literature 1: Japanese Patent Application Laid-open No. 2003-108220

### SUMMARY

### Technical Problem

The present invention has been achieved in view of the above problems, and an object of the present invention is to provide a system construction support apparatus that enables an easy cooperation of a system design support and simulation to enable reduction in the number of processes required for from designing to debugging.

### Solution to Problem

To solve the above-mentioned problems and achieve the object, the present invention comprises: a system design support unit that imports profiles of respective devices constituting an FA system and uses data of the imported profiles to support designing of the FA system; and a simulation unit that simulates an operation of the FA system designed by using the system design support unit. The system design support unit comprises a simulator cooperating function unit that causes the simulation unit to operate in cooperation with the system design support unit. The simulation unit comprises simulators for the respective devices. The system design support unit imports the profiles including simulator information for causing the respective simulators to operate in cooperation with the system design support unit, and thereby the simulator cooperating function unit uses the simulator information to cause the respective simulators to operate.

### Advantageous Effects of Invention

A system construction support apparatus according to the present invention is provided with the simulator cooperating function unit and thus achieves the cooperation of the system design support unit and the simulators by using the profiles. Since the simulator information is described in the profiles, the system construction support apparatus can easily achieve the cooperation of the system design support unit and the simulators. When handling a new device by the system design support tool, the system construction support apparatus can achieve the cooperation with a simulator for the dew device, without extensive modification. In this manner, the system construction support apparatus enables an easy cooperation of the system design support and the simulation and thus brings about an effect that can reduce the number of processes required for from designing to debugging.

### BRIEF DESCRIPTION OF DRAWINGS

FIG. 1 is a block diagram illustrating a schematic configuration of a system construction support apparatus according to an embodiment of the present invention.

FIG. 2 is a diagram illustrating a configuration of hardware having a system design support tool and various simulators installed therein.

FIG. 3 is a block diagram illustrating a configuration of the system design support tool.

FIG. 4 is a diagram illustrating details of contents of a profile.

FIG. 5 is an explanatory diagram of creation of an FA system configuration diagram and generation of a project.

FIG. 6 is an explanatory diagram of execution of a simulator cooperating function in the system design support tool.

FIG. 7 is an explanatory diagram of generation of simulator designation information.

FIG. 8 is an explanatory diagram of generation of simulator notification information.

FIG. 9 is an explanatory diagram of generation of inter-simulator cooperation information.

FIG. 10 is an explanatory diagram of simulation by cooperation of the system design support tool and simulators.

FIG. 11 is an explanatory diagram of display of simulation data.

### DESCRIPTION OF EMBODIMENTS

Exemplary embodiments of a system construction support apparatus according to the present invention will be explained below in detail with reference to the accompanying drawings. It should be noted that the present invention is not limited to the embodiments.

### Embodiment

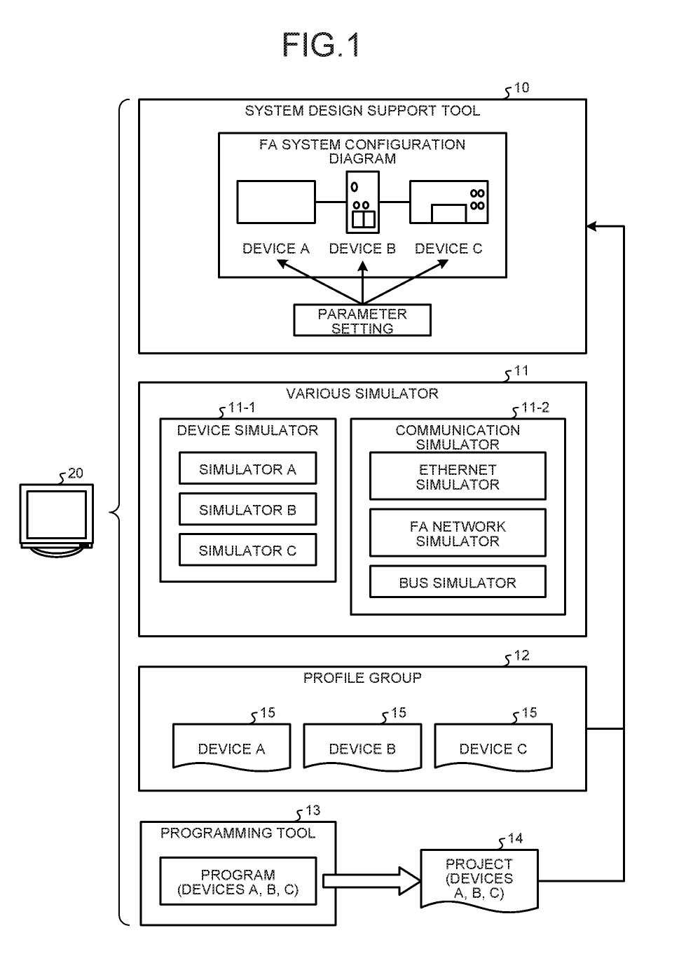

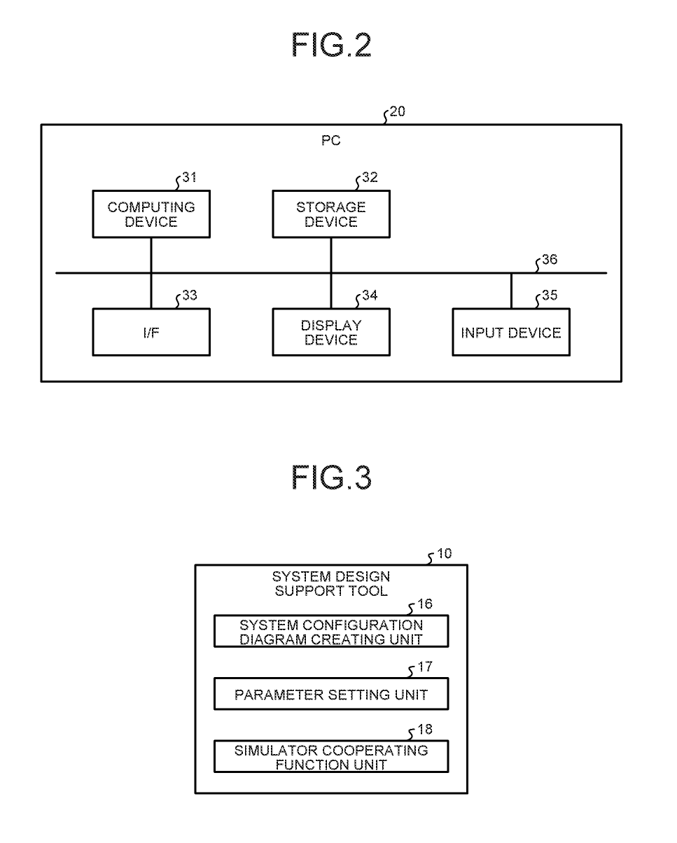

FIG. 1 is a block diagram illustrating a schematic configuration of a system construction support apparatus according to an embodiment of the present invention. FIG. 2 is a diagram illustrating a configuration of hardware in which a system design support tool and various simulators are installed. A system design support tool 10 is software having a function of supporting designing of an FA system. The system design support tool 10 performs creation of a system configuration diagram (system designing), parameter setting and communication setting for respective devices. The system design support tool 10 is installed in the hardware to function as a system design support unit. The system design support unit is a functional unit that imports profiles of respective devices constituting the FA system and uses data of the imported profiles to support designing of the FA system.

Various simulators 11 are various software having a function of simulating an operation of the FA system that is designed by using the system design support tool 10. The various simulators 11 are installed in the hardware to function as a simulation unit. The simulation unit is a functional unit that simulates an operation of the FA system that is designed by using the system design support unit. The simulation unit includes simulators for the respective devices constituting the FA system. The system design support unit and the simulation unit constitute the system construction support apparatus that supports construction of the FA system.

A profile group 12 includes profiles 15 of the respective devices constituting the FA system. The profile 15 includes identification information, information on a communication function, and information on a control function with respect to each of the devices constituting the FA system. Each of the profiles 15 is created as an external file independent of the system design support tool 10. A programming tool 13 is software for creating projects 14 corresponding to the respective devices of the FA system.

For example, the system design support tool 10, the various simulators 11, the profile group 12, and the programming tool 13 are installed in a personal computer (PC) 20 that is hardware.

For example, the PC 20 has a computing device 31 that is a CPU (Central Processing Unit), a storage device 32 consisting of a ROM (Read Only Memory), a RAM (Random Access Memory), an external storage and the like, an interface (I/F) 33 for connection with an external device, a display device 34 such as a liquid crystal display, an input device 35 such as a keyboard and a mouse, and a bus 36 for data communication between these devices.

The computing device 31 creates an FA system configuration diagram by using the system design support tool 10. The display device 34 displays the FA system configuration diagram and data related to the designing, based on an instruction from the computing device 31. A designer operates the input device 35 to input information for designing of the FA system to the PC 20. The input device 35 transmits the input information to the computing device 31.

The storage device 32 holds the system design support tool 10, the various simulators 11, the profile group 12, and the programming tool 13 that are installed in the PC 20. The computing device 31 executes various processing by using the system design support tool 10, the various simulators 11, the profiles 15, and the programming tool 13 that are read out from the storage device 32. Various data generated by the execution of the various processing in the computing device 31 are stored in the storage device 32.

A designer creates a program by performing the processing in the programming tool 13. The programming tool 13 stores the created program as the projects 14 in the storage device 32. The system design support tool 10 imports the profiles 15 and the projects 14 regarding the respective devices constituting the FA system. The system design support tool 10 and the various simulators 11 are installed in the PC 20, the system design support tool 10 imports the respective profiles 15 and projects 14, and thereby the system construction support apparatus is ready for causing the system design support tool 10 and the various simulators 11 to cooperate with each other.

FIG. 3 is a block diagram illustrating a configuration of the system design support tool. The system design support tool 10 has a system configuration diagram creating unit 16, a parameter setting unit 17, and a simulator cooperating function unit 18.

The system configuration diagram creating unit 16 is a functional unit that creates the FA system configuration diagram. The parameter setting unit 17 is a functional unit that sets parameters with respect to the devices constituting the FA system. The simulator cooperating function unit 18 is a functional unit that causes simulators to operate in cooperation with the system design support tool 10 functioning as the system design support unit.

The various simulators 11 include a device simulator 11-1 and a communication simulator 11-2. The device simulator 11-1 performs simulation of the respective devices constituting the FA system. The communication simulator 11-2 performs simulation of respective communication means included in the FA system. The device simulator 11-1 and the communication simulator 11-2 are independent of each other.

In the present embodiment, the FA system that is designed by using the system design support tool 10 includes devices A, B, and C. The device simulator 11-1 includes a simulator A for the device A, a simulator B for the device B, and a simulator C for the device C.

The device simulator 11-1 has a function of representing operations of the respective devices on a virtual space. The device simulator 11-1 may cause the display device 34 to display the operation of the device by means of any of characters, a two-dimensional graphic, a 3-dimensional graphic, a still image, and a moving image. The communication simulator 11-2 has a function of simulating specifications of communications such as the Ethernet (registered trademark), an FA network, and a bus required for the cooperation between the devices.

The profile group 12 includes the profile 15 of the device A, the profile 15 of the device B, and the profile 15 of the device C.

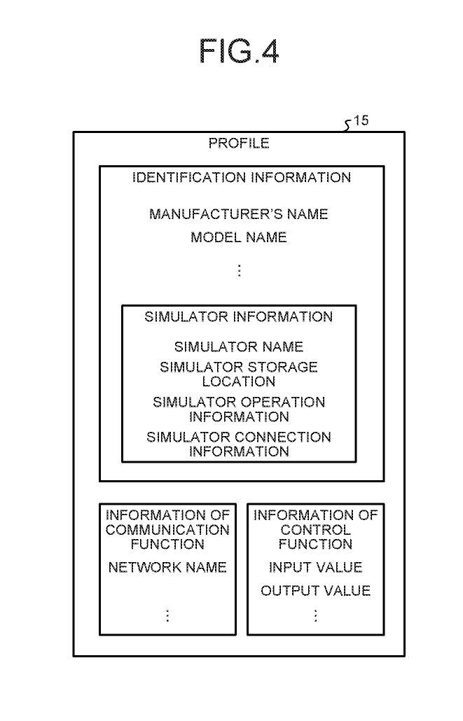

FIG. 4 is a diagram illustrating details of contents of the profile. The profile 15 is configured to include identification information, information on a communication function, and information on a control function of the device. The identification information includes information on the manufacturer's name and model name of the device and simulator information. The information on the communication function is information related to the communication function of an FA system and includes information on a network name. The information on the control function is information related to the control function of the FA system and includes information on an input value and an output value in the FA system.

The simulator information is information for causing simulators for the respective devices to operate in cooperation with the system design support unit. The simulator information includes information on a simulator name and a simulator storage location, simulator operation information, and simulator connection information.

The information on the simulator storage location is an address indicating a location of the simulator in the storage device 32. The simulator operation information is information on operations for activating and stopping the simulator. The simulator connection information is information for obtaining a result of simulation of the entire FA system that is configured by connecting the devices, and is information indicating a relationship of input and output between the devices.

The simulator cooperating function unit 18 of the system design support tool 10 uses the simulator information described in the identification information to cause the various simulators 11 to operate in cooperation with the system design support tool 10. The system design support tool 10 imports the profiles 15 including the simulator information, and thereby the simulator cooperating function unit 18 uses the simulator information to cause the simulators for respective devices to operate.

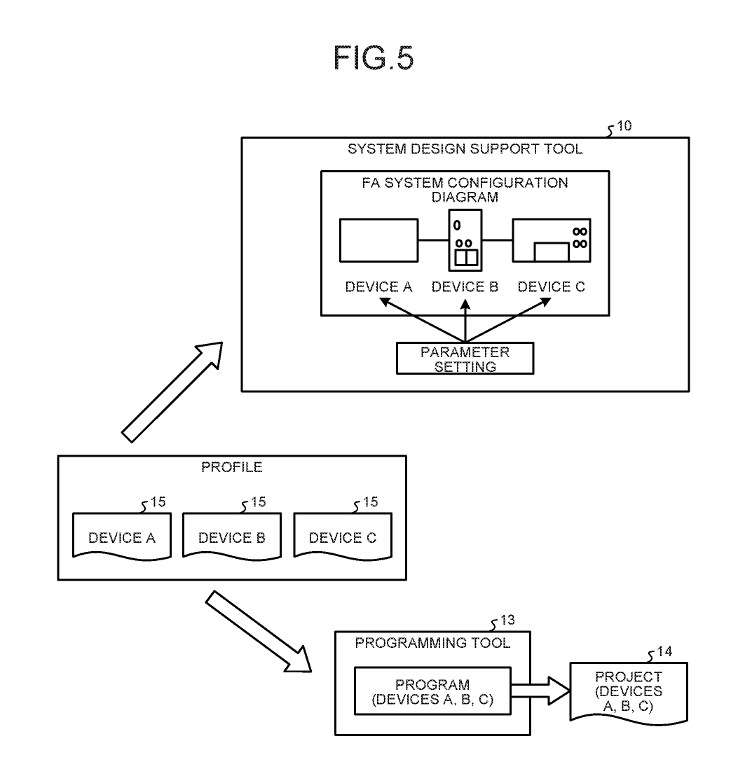

FIG. 5 is an explanatory diagram of creation of the FA system configuration diagram and generation of the projects. As a preparation, the system design support tool 10 imports the profiles 15 including the simulator information. After the preparation is completed, the system construction support apparatus designs the FA system by using the system design support tool 10. The parameter setting unit 17 of the system design support tool 10 uses the profiles 15 to set the parameters of devices. The system configuration diagram creating unit 16 of the system design support tool 10 creates the FA system configuration diagram.

The system construction support apparatus creates programs by using the programming tool 13. For example, the programs include respective programs for the devices A, B, and C. The programming tool 13 stores the created programs as the projects 14 for the respective devices. For example, the projects 14 include respective projects 14 for the devices A, B, and C.

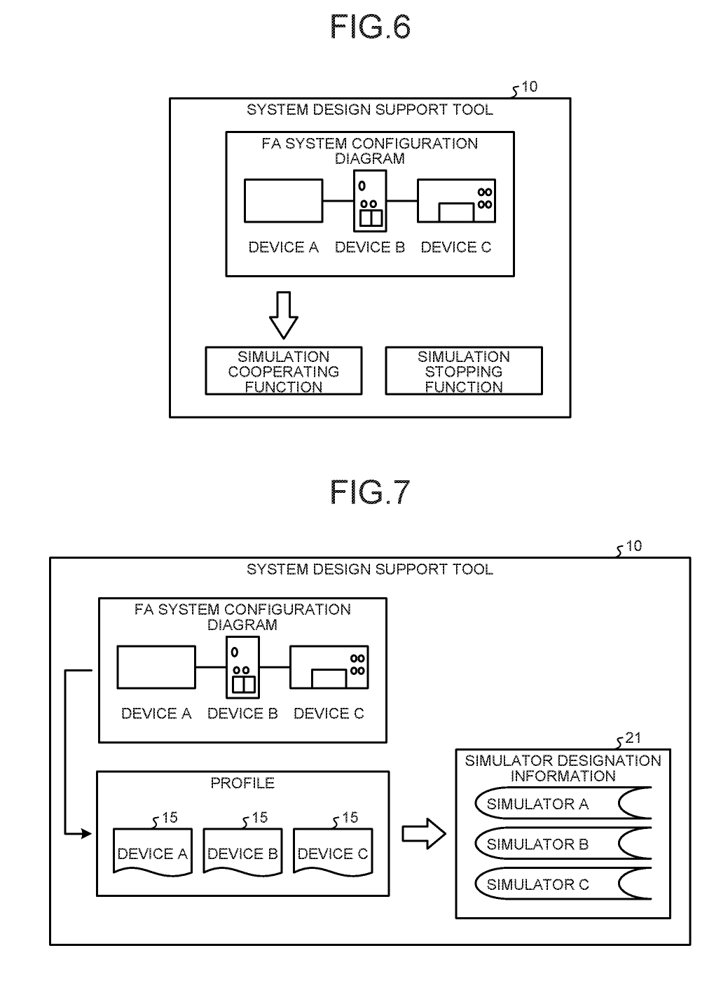

FIG. 6 is an explanatory diagram of execution of a simulator cooperating function in the system design support tool. The system design support tool 10 receives a selection of a device as a simulation target in the designed FA system. For example, the display device 34 displays the FA system configuration diagram including the devices A, B, and C. A designer refers to the FA system configuration diagram displayed on the display device 34 to select a device to be a simulation target. The designer operates the input device 35 to designate a device to be a simulation target.

When the designer selects a device and then issues an instruction to execute the simulation cooperating function by operating the input device 35, the simulator cooperating function unit 18 instructs a simulator for the selected device to start operating. As a result, the simulator for the selected device performs the simulation.

When the designer issues an instruction to execute a simulation stopping function by operating the input device 35 while the simulator is performing the simulation, the simulator cooperating function unit 18 instructs the simulator to stop the simulation. The simulator having received the instruction to stop the simulation from the simulator cooperating function unit 18 stops the simulation.

The simulator cooperating function unit 18 generates the instruction to activate the simulator and the instruction to stop the simulation based on the simulator operation information included in the simulator information in the profile 15. The simulator operation information includes trigger information for activating and stopping the simulator for each device. The system construction support apparatus transmits the trigger information to the simulator for the each device via the simulator cooperating function unit 18.

The simulator cooperating function unit 18 generates information for designating a simulator to be activated (simulator designation information), information to be notified to the activated simulator (simulator notification information), and information for causing the simulators to cooperate with each other (inter-simulator cooperation information). When executing the simulation cooperating function, the simulator cooperating function unit 18 generates the simulator designation information, the simulator notification information, and the inter-simulator cooperation information.

FIG. 7 is an explanatory diagram of generation of the simulator designation information. The simulator cooperating function unit 18 generates the simulator designation information 21 by using the information on the simulator name the simulator storage location and the simulator operation information included in the simulator information for the selected device in the profiles 15. When any of the devices A, B, and C is selected, the simulator cooperating function unit 18 generates the simulator designation information 21 for designating the simulator A, B, or C according to the selection.

In a case where a new device is handled by the system design support tool 10, the system construction support apparatus creates a profile 15 including simulator information on a simulator for the new device. As a result, the system construction support apparatus can achieve the cooperation between the system design support tool 10 and the simulator with respect to the new device. The system construction support apparatus can easily achieve the cooperation with the simulator for the new device, without depending on development of the system design support tool 10.

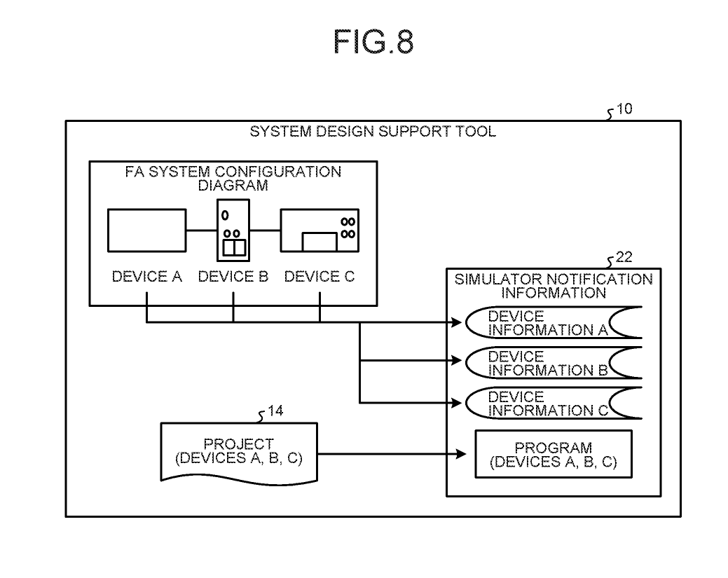

FIG. 8 is an explanatory diagram of generation of the simulator notification information. The simulator cooperating function unit 18 acquires device setting information on setting of the respective devices constituting the FA system from the projects 14 and setting of the respective devices in the FA system configuration diagram. For example, the simulator cooperating function unit 18 acquires, from the FA system configuration diagram, the device setting information (device information A, device information B, and device information C) that is information on parameter setting, communication setting, automatic refresh setting, and link refresh setting of the respective devices. The simulator cooperating function unit 18 acquires, from the projects 14, programs for operating the respective devices. The simulator cooperating function unit 18 generates the simulator notification information 22 based on the acquired information.

The simulator notification information 22 includes the device information A, the device information B, the device information C, and the programs for operating the respective devices A, B, and C. The function of generating such the simulator notification information 22 can be provided as a function that does not depend on a device to be the simulation target. In a case where a new device is handled by the system design support tool 10, the system construction support apparatus can generate the simulator notification information 22 for the new device by using the simulator cooperating function unit 18, without redeveloping the function of generating the simulator notification information 22. The system construction support apparatus can easily achieve the cooperation with the simulator for the new device, without depending on development of the system design support tool 10.

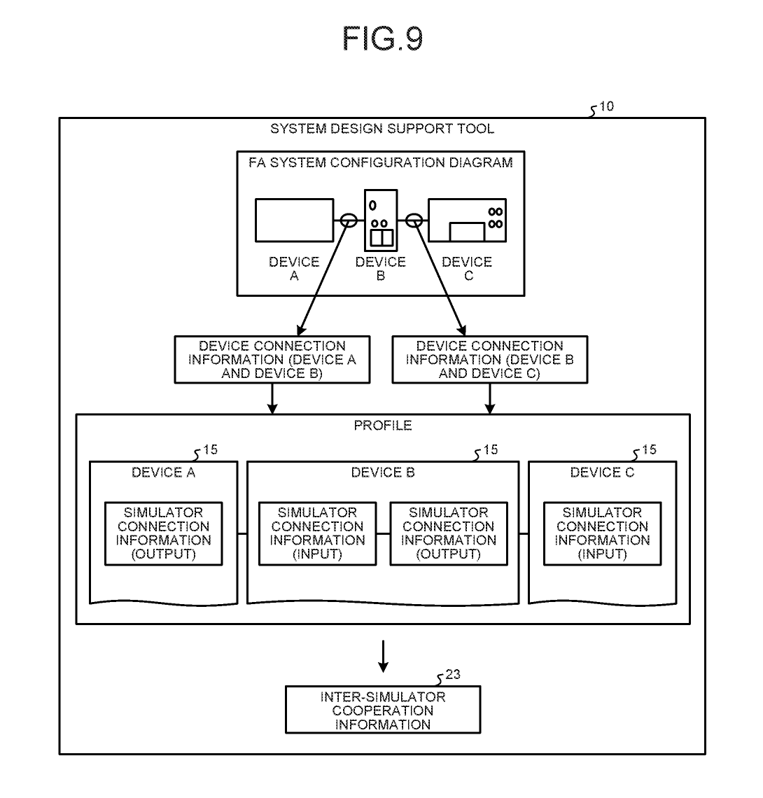

FIG. 9 is an explanatory diagram of generation of the inter-simulator cooperation information. The simulator cooperating function unit 18 acquires device connection information from the FA system configuration diagram. The device connection information is information indicating a connection relationship between the devices constituting the FA system. For example, the simulator cooperating function unit 18 acquires, from the FA system configuration diagram in which the devices A, B, and C are serially connected, the device connection information indicating a connection between the devices A and B and the device connection information indicating a connection between the devices B and C.

In addition, the simulator cooperating function unit 18 acquires the simulator connection information from the profiles 15 of the respective devices. In this example, the simulator cooperating function unit 18 acquires the simulator connection information on an output of the device A from the profile 15 of the device A. The simulator cooperating function unit 18 acquires the simulator connection information on an input of the device B and the simulator connection information on an output of the device B from the profile 15 of the device B. The simulator cooperating function unit 18 acquires the simulator connection information on an input of the device C from the profile 15 of the device C.

The simulator cooperating function unit 18 combines the acquired device connection information and simulator connection information to generate inter-simulator cooperation information 23 for causing the simulators to cooperate with each other. The inter-simulator cooperation information 23 is interface information between the devices constituting the FA system.

The function of generating such the inter-simulator cooperation information 23 can be provided as a function that does not depend on a device to be the simulation target. In a case where a new device is handled by the system design support tool 10, the system construction support apparatus can generate the inter-simulator cooperation information 23 for the new device by using the simulator cooperating function unit 18, without redeveloping the function of generating the inter-simulator cooperation information 23. The system construction support apparatus can easily achieve the cooperation with the simulator for the new device, without depending on development of the system design support tool 10.

The simulator cooperating function unit 18 generates the simulator designation information 21 shown in FIG. 7, the simulator notification information 22 shown in FIG. 8, and the inter-simulator cooperation information 23 shown in FIG. 9, at a timing when executing the simulation cooperating function.

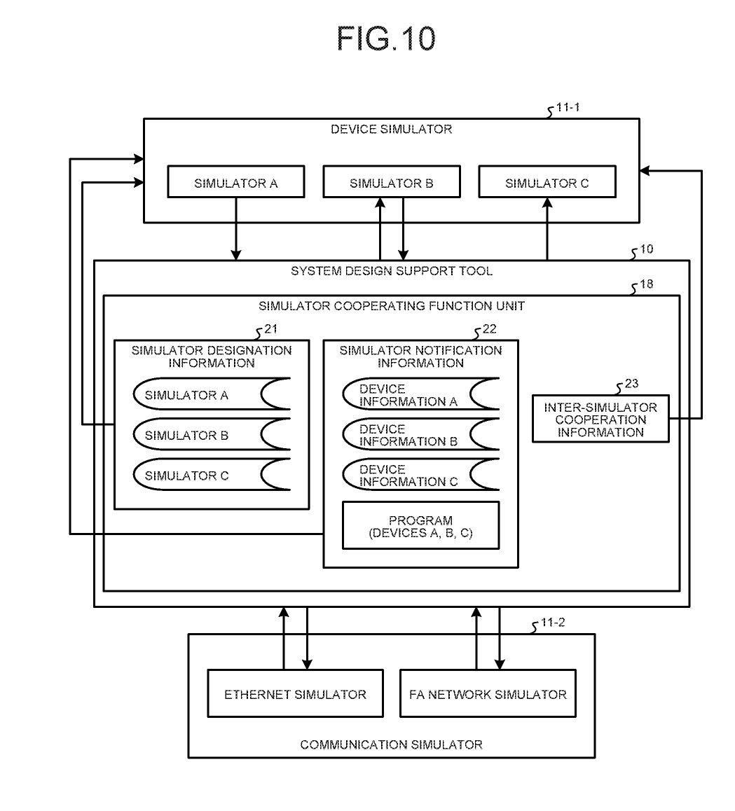

FIG. 10 is an explanatory diagram of the simulation by the cooperation of the system design support tool and the simulators. The simulator designation information 21 and the simulator notification information 22 generated by the simulator cooperating function unit 18 are input to the device simulator 11-1. The simulator cooperating function unit 18 activates the simulators A, B, and C by inputting the simulator designation information 21 and the simulator notification information 22 to the device simulator.

The simulator A acquires information on the communication setting of the device A from the simulator notification information 22. The simulator A acquires the connection information related to the device A from the inter-simulator cooperation information 23. The simulator A transmits the acquired information on the communication setting and the acquired connection information to the simulator cooperating function unit 18. In addition, the simulator A transmits simulation data regarding the device A to the simulator cooperating function unit 18. The simulation data indicates a result of the simulation with regard to the device and, for example, includes information on ON/OFF of the device.

The simulator B acquires information on the communication setting of the device B from the simulator notification information 22. The simulator B acquires the connection information related to the device B from the inter-simulator cooperation information 23. The simulator B transmits the acquired information on communication setting and the acquired connection information to the simulator cooperating function unit 18. In addition, the simulator B transmits the simulation data regarding the device B to the simulator cooperating function unit 18.

The simulator C acquires information on the communication setting of the device C from the simulator notification information 22. The simulator C acquires the connection information related to the device C from the inter-simulator cooperation information 23. The simulator C transmits the acquired information on communication setting and the acquired connection information to the simulator cooperating function unit 18. In addition, the simulator C transmits the simulation data regarding the device C to the simulator cooperating function unit 18.

The simulator cooperating function unit 18 relays information communication between the device simulator 11-1 and the communication simulator 11-2. The simulator cooperating function unit 18 transmits, to the communication simulator 11-2, the information on the communication setting, the connection information, and the simulation data received from the simulators A, B, and C.

The simulator A transmits, to the simulator cooperating function unit 18, the simulation data indicating a result of the simulation, the information on the communication setting, and the connection information. The simulator cooperating function unit 18 transmits, to an Ethernet simulator for example, the information on the communication setting, the connection information, and the simulation data received from the simulator A. The Ethernet simulator converts the simulation data in accordance with a communication format used by the device A, based on the information on the communication setting regarding the device A. Based on the connection information related to the device A, the Ethernet simulator sets the post-conversion simulation data as a data for the simulation B regarding the device B that is a connection destination of the device A. The Ethernet simulator transmits the simulation data for the simulation B to the simulator cooperating function unit 18.

The simulator cooperating function unit 18 transfers the simulation data from the Ethernet simulator to the simulator B. The simulator B performs simulation using the simulation data. The simulator B transmits, to the simulator cooperating function unit 18, the simulation data indicating a result of the simulation, the information on the communication setting, and the connection information.

The simulator cooperating function unit 18 transmits, to an FA network simulator for example, the information on the communication setting, the connection information, and the simulation data received from the simulator B. The FA network simulator converts the simulation data in accordance with a communication format used by the device B, based on the information on the communication setting regarding the device B. Based on the connection information related to the device B, the FA network simulator sets the post-conversion simulation data as a data for the simulation C regarding the device C that is a connection destination of the device B. The FA network simulator transmits the simulation data for the simulation C to the simulator cooperating function unit 18.

The simulator cooperating function unit 18 transfers the simulation data from the FA network simulator to the simulator C. The simulator C performs simulation using the simulation data. In this manner, the system construction support apparatus performs the simulation of the FA system including the devices A, B, and C by causing the simulators A, B, and C to operate in cooperation with the system design support tool 10.

According to the present embodiment, the system construction support apparatus selects the devices constituting the FA system and activates the simulators for the selected devices to perform the simulation. The system construction support apparatus can easily check and verify the operation of the FA system by causing the simulators to cooperate with the system design support tool.

Since the simulator information is described in the profiles 15, the system construction support apparatus can easily achieve the cooperation of the system design support tool 10 and the simulators. When handling a new device by the system design support tool 10, the system construction support apparatus can achieve the cooperation with a simulator for the dew device, without extensive modification to the system design support tool 10. In this manner, the system construction support apparatus enables an easy cooperation of the system design support and the simulation and thus brings about an effect that can reduce the number of processes required for from designing to debugging.

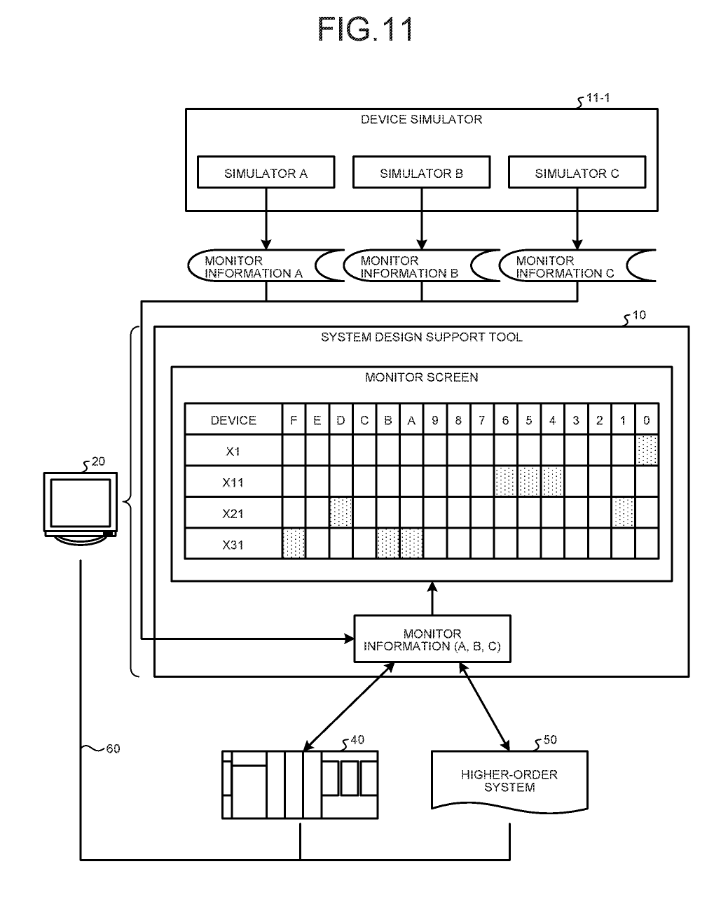

FIG. 11 is an explanatory diagram of display of the simulation data. The simulator A outputs the simulation data regarding the device A as monitor information A. The simulator A transmits the monitor information A to the simulator cooperating function unit 18 of the system design support tool 10.

The simulator B outputs the simulation data regarding the device B as monitor information B. The simulator B transmits the monitor information B to the simulator cooperating function unit 18 of the system design support tool 10. The simulator C outputs the simulation data regarding the device C as monitor information C. The simulator C transmits the monitor information C to the simulator cooperating function unit 18 of the system design support tool 10.

Upon reception of the monitor information A, B, and C, the simulator cooperating function unit 18 outputs, to the display device 34, the received monitor information A, B, and C as a data for displaying a monitor screen. The display device 34 displays the monitor screen corresponding to the monitor information. A detailed description of contents of the monitor screen is omitted.

The system construction support apparatus displays the simulation data obtained by the various simulators 11 as a monitor screen. Based on the display of the monitor screen, a designer can easily assess whether or not the FA system is so designed as to operate normally. Besides using the monitor information for display of the monitor screen, it is also possible that the simulator cooperating function unit 18 uses the monitor information in any means that can verify the operation of the FA system.

Furthermore, it is also possible that the simulator cooperating function unit 18 causes the various simulators 11 to cooperate with a higher-order system 50 than the system construction support apparatus or an actual device 40 of the FA system. The actual device 40 of the FA system and the higher-order system 50 are communicatively connected to the PC 20 through a communication path 60.

The simulator cooperating function unit 18 causes the various simulators 11 to cooperate with the higher-order system 50, and thereby causes the various simulators 11 to perform a simulation including data communication with the higher-order system 50. As a result, the system construction support apparatus can perform a simulation by the cooperation between the system design support tool 10, the various simulators 11, and the higher-order system 50. For example, the system construction support apparatus may perform the simulation by the cooperation with the higher-order system 50, before construction of the FA system as the actual device 40.

The simulator cooperating function unit 18 causes the various simulators 11 to cooperate with the actual device 40, and thereby causes the various simulators 11 to perform a simulation including data communication with the actual device 40. As a result, the system construction support apparatus can perform a simulation by the cooperation between the system design support tool 10, the various simulators 11, and the actual device 40.

### REFERENCE SIGNS LIST

10 system design support tool, 11 various simulator, 11-1 device simulator, 11-2 communication simulator, 12 profile group, 13 programming tool, 14 project, 15 profile, 16 system configuration diagram creating unit, 17 parameter setting unit, 18 simulator cooperating function unit, 20 PC, 21 simulator designation information, 22 simulator notification information, 23 inter-simulator cooperation information, computing device, 32 storage device, 33 I/F, 34 display device, 35 input device, 36 bus, 40 actual device, 50 higher-order system, 60 communication path.

1. A system construction support apparatus comprising:
a system design support unit that imports profiles of respective devices constituting an FA system and uses data of the imported profiles to support designing of the FA system; and
a simulation unit that simulates an operation of the FA system designed by using the system design support unit, wherein
the system design support unit comprises a simulator cooperating function unit that causes the simulation unit to operate in cooperation with the system design support unit,
the simulation unit comprises simulators for the respective devices,
the system design support unit imports the profiles including simulator information for causing the respective simulators to operate in cooperation with the system design support unit, and thereby the simulator cooperating function unit uses the simulator information to cause the respective simulators to operate.

2. The system construction support apparatus according to claim 1, wherein
the simulator cooperating function unit uses the simulator information to generate simulator designation information for designating the simulators to be activated.

3. The system construction support apparatus according to claim 1, wherein
the simulator cooperating function unit acquires device setting information on setting of the respective devices from a configuration diagram of the FA system, and uses the device setting information to generate simulator notification information that is to be notified to the respective simulators.

4. The system construction support apparatus according to claim 1, wherein
the simulator cooperating function unit acquires device connection information on connection between the devices from a configuration diagram of the FA system, and uses the device connection information to generate inter-simulator cooperation information for causing the simulators to cooperate with each other.

5. The system construction support apparatus according to claim 1, wherein
the simulators output, as monitor information, simulation data indicating a result of simulation, and
the simulator cooperating function unit outputs, as a data for displaying a monitor screen, the monitor information output from the simulators.

6. The system construction support apparatus according to claim 1, wherein
the simulator cooperating function unit causes the simulators to further perform a simulation including data communication with a higher-order system than the system construction support apparatus.

7. The system construction support apparatus according to claim 1, wherein
the simulator cooperating function unit causes the simulators to further perform a simulation including data communication with an actual device of the FA system.
